(19) United States
(12) Patent Application Publication
(10) Pub. No.: US 2010/0287129 A1
(43) Pub. Date: Nov. 11, 2010

(54) SYSTEM, METHOD, OR APPARATUS RELATING TO CATEGORIZING OR SELECTING POTENTIAL SEARCH RESULTS

(75) Inventors: Kostas Tsioutsiouliklis, San Jose, CA (US); Su Han Chan, Sunnyvale, CA (US); Sean Suchter, Sunnyvale, CA (US); Andrew Tomkins, Sunnyvale, CA (US); Arnab Bhattacharjee, Sunnyvale, CA (US); Dmitri Pavlovski, San Francisco, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo!, Inc., a Delaware corporation, Sunnyvale, CA (US)

(21) Appl. No.: 12/437,043

(22) Filed: May 7, 2009

(51) Int. Cl. G06N 5/02

(52) U.S. Cl. 706/46

(57) ABSTRACT

Embodiments of methods, apparatuses, devices and systems associated with categorizing or selecting potential search engine results are disclosed.

### FIELD

Embodiments relate to the field of search engines, and more specifically to categorizing search results from a search engine.

### BACKGROUND

The World Wide Web provides access to vast quantities of information and documents. In order to help users access relevant information it may, under some circumstances, be desirable to employ one or more search engines to try to locate information relevant to one or more queries. For example, a user may submit a search query to a search engine and a search engine may return one or more results to the user. However, the results returned to a user may not be the most relevant or useful results for a particular search query. Accordingly, it may be desirable to improve ways in which search results are ranked or provided to users.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a schematic diagram of a system in accordance with an embodiment;

FIG. 2 is a flow chart depiction of a system or process in accordance with an embodiment;

FIG. 3 is a schematic diagram of a system in accordance with an embodiment; and

FIG. 4 is a schematic diagram of a special purpose computing apparatus in accordance with an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, procedures, components or circuits that would be known by one of ordinary skill have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

The world wide web provides access to vast quantities of information and documents. In order to help users access relevant information it may, under some circumstances, be desirable to employ one or more search engines to try to locate information relevant to one or more queries. For example, a user may submit a search query to a search engine and a search engine may return one or more results to the user. However, the results returned to a user may not be the most relevant or useful results for a particular search query. Accordingly, it may be desirable to improve ways in which search results are ranked or provided to users. For example, it may be desirable for a search engine to organize potential search results based at least in part on an expected response to those results. In this example, an expected response to such search results may include a variety of factors, such as a likelihood of a particular result being provided to a user, a likelihood of a particular result being selected by a user, such as by using an input of a computing apparatus in conjunction with a web browser or other user interface, a likelihood of a user finding desirable information from a particular result, or the like. In one or more embodiments, a graphical user interface (GUI) may refer to a program interface that utilizes displayed graphical information to allow a user to control or operate a special purpose computing platform, for example. A pointer may refer to a cursor or other symbol that appears on a display that may be moved or controlled with a pointing device to select objects or input commands via a GUI of a special purpose computing platform, for example. A pointing device may refer to a device used to control a cursor, to select search results, or to input information such as commands for example via a GUI of a special purpose computing platform, for example. Such pointing devices may include, for example, a mouse, a trackball, a track pad, a track stick, a keyboard, a stylus, a digitizing tablet, or similar types of devices. A cursor may refer to a symbol or a pointer where an input selection or actuation may be made with respect to a region in a GUI. Herein, terms such a “click” or “clicking” may refer to a selection process made by any pointing device, such as a mouse for example, but use of such terms is not intended to be so limited. For example, a selection process may be made via a touch screen. However, these are merely examples of methods of selecting search results or inputting information, such as one or more search queries, and claimed subject matter is not limited in scope in these respects. In an embodiment, it may be desirable to organize potential search results so that more desirable or relevant search results may be more likely to be presented to a user in response to a search query. For example, search results that are deemed more likely to be desirable or relevant may be placed in a higher category of search results, while search results that are deemed less likely to be desirable or relevant may be placed in lower categories of search results. In this example, in processing a search query a search engine may prioritize finding search results from higher categories so that a user may be more likely to be presented with desirable search results relevant to the search query. For example, if a user enters a search query for a particular news topic, such as a recent election or other event, search results relating to that election or event may be desirable or relevant. In addition, search results relating to that election or event from one or more authoritative news sources may be deemed more desirable than search results from less authoritative news sources. However, it should be noted that these are merely illustrative examples relating to search results and that claimed subject matter is not limited in this regard.

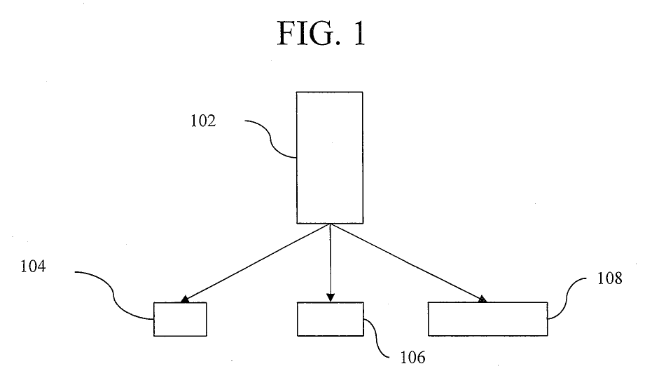

In an embodiment, such as that shown in FIG. 1, it may be desirable to organize potential search results into one or more categories. For example, it may be desirable for a system, such as special purpose computing apparatus 102 to organize search results into one or more categories or tiers, such as hierarchical tiers 104, 106, and/or 108, based at least in part on a determined or perceived relevance of such search results. In this example, a perceived relevance may be determined by a human or user assigned grade. For example, a user may evaluate a search result and assign a grade to that result based at least in part with how closely such a result is relevant to one or more search terms (e.g. search terms in a query). In addition, a perceived relevance may also be determined by one or more relevance functions or processes. For example, a machine learning process may evaluate a feature vector associated with one or more search results and assign a relevance score to those search results based at least in part on one or more factors or aspects of their respective feature vectors. In an embodiment, a feature vector may comprise a multidimensional vector including one or more numerical representations of one or more aspects of a particular search result. For example, a feature vector may include information indicating a source of a search result, a representation of a number of times that one or more search query terms appear in a search results, a representation of a number of external hyperlinks to a search result, a representation of text associated with a link to a search result, a size associated with a search result, an indication of one or more image, audio, or video aspects associated with a search result, or the like. For example, a feature vector associated with a news article may indicate a source of that article, such a Yahoo! News for example. The feature vector for such an article may also include an indication of whether one or more search query terms appear in the article, an indication of a number of hyperlinks from external web sites that link to the particular article, or the like. In this example, a relevance function may analyze such a feature vector to determine a relevance score for that news article in relation to one or more search query terms. Of course, it should be noted that these are merely illustrative examples of information that may be included in a feature vector and claimed subject matter is not limited in this regards. For example, a relevance function may evaluate one or more aspects of a search result, such as by evaluating a feature vector associated with that search result. In this example, the relevance function may evaluate information from the feature vector such as a source of a search result, such as a particular web page, an author of a search results, a number of links to a search result, text associated with links to a search result, an authoritative aspect of the search result, one or more linguistic aspects of the search results, one or more image, audio, or video aspects of a search result, or the like, and determine a relevance score based at least in part on the considered aspects. In this example, search results with a relatively high perceived relevance, such as those search results having a relevance score above a threshold value, may be associated with or stored at a first tier, such as tier 104, for example. On the other hand, search results having a relatively lower perceived relevance, such as those search results having a relevance score below such a threshold value, may be associated with or stored at a second tier, such as tiers 106 or 108, for example. In an embodiment, different tiers may include different quantities of search results. For example a first tier may only include only a small percentage of search results, such as 1 or 2 percent of search results, while subsequent lower level tiers may include progressively higher percentages of search results. In addition, a quantity of search results stored at each tier may vary over time due to one or more system constraints, such storage space or performance characteristics, for example. In addition, additional lower level tiers may be established for search results having lower perceived relevance.

In an embodiment, if a search engine, such as system 102, receives a user query, the search engine may attempt to satisfy the query by first checking for appropriate search results in tier 104, and if appropriate continue checking for additional results in lower level tiers, such as tiers 106 or 108. For example, a first tier, such as tier 104, may contain a relatively small number of search results having a high perceived relevance for a particular received search query. In this example, system 102 may be able to satisfy a user query from tier 104 without continuing to check lower level tiers for additional search results. Such circumstances may improve latency for returning search engine results. If, however, a search engine continues on to check the lower level tiers, such as tier 106 and 108, for relevant search results latency may be increased. Accordingly, it may be desirable to improve a relative quality of search results stored in, or associated with a first category or tier, such as tier 104, at least in part to improve one or more aspects, such as latency, of search engine performance. It should, however, be noted that these are merely illustrative examples relating to search engine results and that claimed subject matter is not limited in this regard.

In an embodiment, one or more search results may be assigned to one or more categories based at least in part on a determined relevance of such search results one or more search queries. As used herein, categories may refer to one or more ways of storing or associating search results. For example, a category may comprise a tier, such as discussed above. For additional example, a category may comprise search results associated with one or more business partners, such as paid advertisers, or the like. In addition, categories may be associated with particular storage locations, memory devices, such as one or more memory devices associated with a special purpose computing apparatus, or computing apparatuses. For example, a first tier may be represented by one or more signals stored at a first memory location, or at a first computing apparatus, while other tiers may be represented by one or more other signals stored at different memory locations or at different computing apparatuses. In an embodiment, a relevance function or process may determine a relevance score for one or more search results based at least in part on one or more aspects of features vectors, such as one or more of the example aspects of a feature vector discussed above, associated with those search results and those search results may be assigned to one or more categories based at least in part on their respective relevance scores. For example, a relevance function may employ statistical analysis of one or more aspects of a feature vector at least in part to determine a relevance score for a corresponding search result. Under some circumstances, such a relevance score may be represented at least in part as a numerical value. For additional example, one or more human graders or users may assign a grade to one or more search results and those search results may be assigned to one or more categories based at least in part on their respective user assigned grades. Under some circumstances, one or more search results may be assigned to one or more categories based at least in part on a combination of relevance function determined relevance score and a user assigned grade. In this example, if a search engine receives a user query, the search engine may search through the one or more categories of potential search results and return a set of search results to a user. In this example, the search engine or an application program running on a special purpose computing apparatus may track one or more user interactions with the returned set of search results. For example, a special purpose computing apparatus may track which search results are selected by users, such as by using an input device of a computing apparatus. In addition, a special purpose computing apparatus may track additional details about ways in which users interact with particular search results. For example, a special purpose computing apparatus may track how long a user interacts with a particular search result, whether a user discontinues their search or reformulates their search, or the like. In addition, a special purpose computing apparatus may track which search results from a particular category of search results are displayed to a user in response to a search query. In this example, a special purpose computing apparatus running one or more tracking application programs may gather tracking data about particular search results, including data relating to user selections, user behavior, and if particular search results are displayed to a user, and may store the gathered tracking information as a user behavior log or log file. In an embodiment, it may be desirable to re-rank or re-categorize one or more search results based at least in part on the gathered tracking data. For example, the gathered tracking data may be used in conjunction with one or more relevance scores, grades, or feature vectors at least in part to determine a correlation between the tracking data and the search results and to re-categorize or re-assign particular search results to other tiers or categories of search results. For example, if a particular search result was stored in a lower tier, such as tier 106, it may be reassigned to a higher tier, such as tier 104, based at least in part on the gathered tracking data, a determined correlation and one or more aspects of a feature vector corresponding to the particular search result. In this example, if a particular search result stored in tier 106 is more likely to be displayed to a user or selected by a user than one or more search results stored in tier 104, it may be desirable to reassign such a search result from tier 106 to tier 104. By way of example, if a news article from a less authoritative web site were stored in tier 106, but was more likely, based on an analysis of the gathered tracking data, to be displayed to a user in a list of search results and more likely to be clicked on by a user than a similar article from a more authoritative source, then it may be desirable to reassign the first article from tier 106 to tier 104. In this way, the search engine can locate that more desirable article without continuing on to search tier 106. It should, however, be noted that these are merely illustrative examples relating to categorizing search results and that claims subject matter is not limited in this regard.

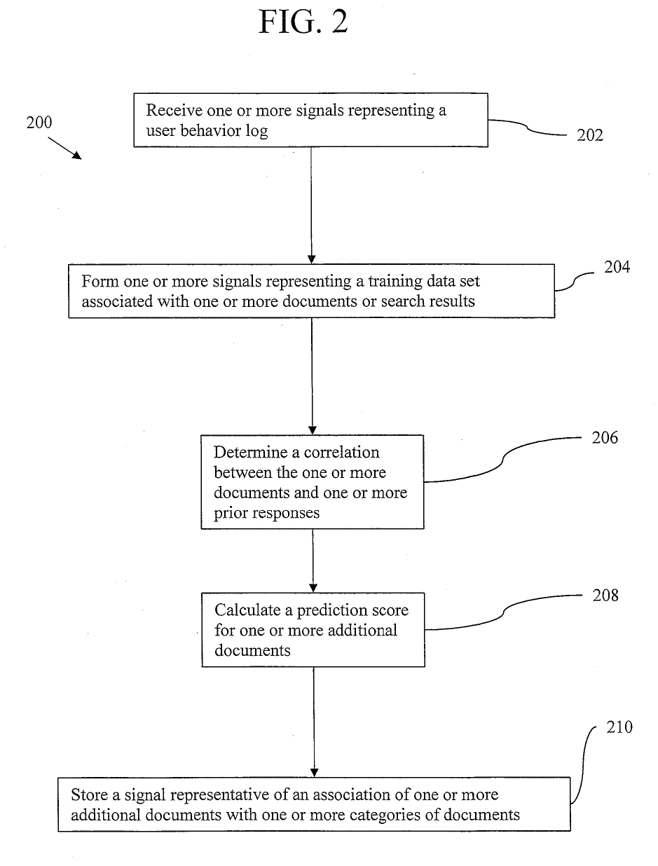

FIG. 2 is a flow chart depiction of a system or process in accordance with an embodiment 200. With regard to box 202, a system or process in accordance with embodiment 200 may receive via a network communication adaptor of a special purpose computing apparatus one or more signals representing a user behavior log. As used herein, a user behavior log may refer to one or more files representing one or more aspects of user behavior. For example, a user behavior log may include information relating to which search results have been displayed to a user, which search results have been selected by a user, how a user interacted with a particular search result, how long a user interacted with a particular search result, or the like. As discussed above, a special purpose computing apparatus executing one or more tracking application programs may gather tracking information and at least in part form a log or log file of such information. In this example, a special purpose computing apparatus may track signals representing such user behavior, such as signals from a search engine program, a user application program, such as a web browser, or the like, and may store such signals in a log or other file. In this embodiment, the user behavior log may be received by a system or process. For example, a special purpose computing apparatus executing one or more tracking programs may transmit such a user behavior log to a system or process from time to time, such as in response to a request from such system or process. With regard to box 204, a system or process may execute one or more instructions on a special purpose computing apparatus to form one or more signals representing a training data set associated with one or more documents based at least in part on one or more portions of information derived from the received user behavior log. As used herein, a document or search result may refer to one or more signals that may be stored in a machine readable format. For example, a document or file may comprise one or more signals representing one or more portions of information such as text, sound, video, images, or the like that may be manipulated, executed, interpreted, rendered, displayed, played, or the like by one or more special purpose computing apparatuses. As used herein, a training set may refer to a data set that may be used by one or more machine learning processes or algorithms at least in part to evaluate one or more corresponding search results. For example, a training set may refer to one or more documents or their corresponding feature vectors, such as one or more documents that may be represented as one or more signals stored in one or more tiers, along with, or in association with, one or more signals representative of one or more portions data from a user behavior log corresponding to those search results. For example, a training set may include one or more search results that have been displayed to a user, selected by a user, or interacted with by a user as shown by one or more aspect of the user behavior log. In addition, a training set may include one or more aspects of feature vectors corresponding to such search results. In this embodiment, a machine learning process may analyze one or more aspects of the feature vectors along with information from the user behavior log at least in part to determine correlation between aspects of the feature vector and portions of the behavior log along with a desirability to re-categorize a particular document. If, for example it is determined that a search result is more likely to be displayed to a user or selected by a user it may be desirable to re-categorize such a search result into a higher category or tier of search results. Likewise, if it is determined that another search result is less likely to be displayed to a user or selected by a user it may be desirable to re-categorize that search result into a lower category or tier of search results. As just one example, consider a function that grades documents on a scale from 0-100. In this example, a grade of zero may represent a low likelihood or relevance for a particular document while a grade of 100 may represent a high likelihood of relevance for a particular document. As just one example of a threshold value, particular documents having scores of 90 or greater may be categorized into a first tier of documents, while particular documents having scores between 70 and 90 may be categorized into a second tier of documents, and so on. It should, however, be noted that these are merely illustrative examples relating to search results and that claimed subject matter is not limited in this regard.

With regard to box 206, a system or process in accordance with embodiment 200 may determine a correlation between one or more aspects of the search results and any prior user response to those search results, such as prior responses determined from the user behavior log. For example, consider a web site that particular users tend to click on regularly when that web site is displayed along with other search results. If, for example, there are a number of documents from that particular web site categorized in a lower tier of documents, it may be desirable to re-categorize such documents into a higher tier. As used herein, a prior user response may refer to a response determined from a user behavior log to a particular search result. For example, a prior response may refer to a likelihood of a search engine having included a particular search result in a prior set of search results returned to a user. For addition example, a prior response may refer to one or more expected user interactions with a particular search result, such as a likelihood of a user to select on a particular search result from a prior set of search results. In an embodiment, a system or process may determine a correlation at least in part by analyzing one or more aspects of a feature vector along with one or more aspects of the user behavior log at least in part to determine correlations between aspects of the feature vectors and user behavior. With regard to box 208, a system or process in accordance with embodiment 100 may calculate a prediction score for one or more additional documents based, at least in part, on the determined correlation for the training set. Here, a prediction score may refer to a likelihood of a user or a search engine having a particular response to a particular search result based at least in part on one or more determined correlations to prior responses for other search results. In an embodiment, a prediction score may comprise a sum of one or more likelihoods associated with one or more aspects of a feature vector associated with a particular document or search result. For example, a system or process may have determined that a document from the training set having certain characteristics, such as characteristics reflected in a feature vector associated with a document, may have a particular likelihood of eliciting a particular response. Accordingly, a system or process may calculate a prediction score for one or more additional documents having those certain features based at least in part on the correlation between the prior responses and the documents, search results, or feature vectors from the training set. For example, a system or process may compare one or more aspects of a feature vector for an additional document to one or more aspects of a feature vector for a document from the training set along with the determined correlations to user behavior and calculate a prediction score for that additional document based at least in part on the comparison. In an embodiment, this process may be employed for any number of additional documents or search results. With regard to box 210, a system or process in accordance with embodiment 200 may store a signal representative of an association of one or more additional documents with one or more categories of documents based at least in part on the prediction scores calculated for said one or more additional documents. For example, one or more additional documents having a prediction score above a threshold value may be associated with, and/or represented by signals stored at, a first tier of documents, such as tier 104 of FIG. 1, while one or more additional documents having a prediction score below a threshold value may be associated with, and/or represented by signals stored at a second tier of documents, such as tier 106 of FIG. 1, and so on. In this embodiment, documents having higher prediction scores may be categorized such that those documents are more likely to be returned in response to a user search query. However, it should be noted that these are merely illustrative examples relating to categorizing search results and that claimed subject matter is not limited in this regard.

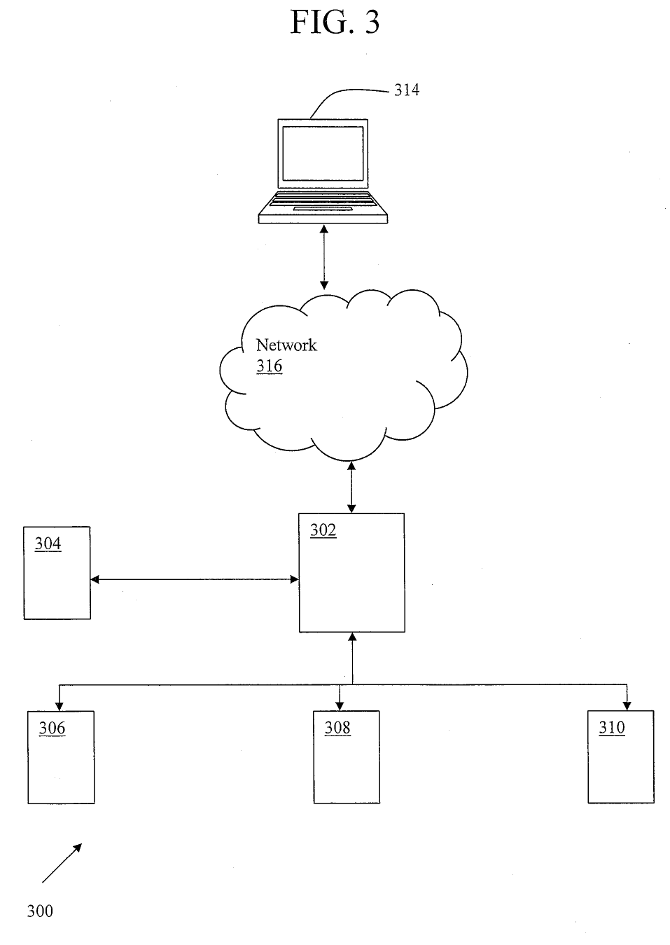

FIG. 3 is a schematic diagram of a system in accordance with an embodiment 300. With regard to FIG. 3, a special purpose computing apparatus, such as computing apparatus 302 may receive via a network communication adaptor (not shown) one or more signals representing a user behavior log. In this example, computing apparatus 302 may receive the user behavior log from one or more additional computing apparatuses, such as computing apparatus 304, which may be executing one or more tracking application programs, at least in part to track information from a search engine or a user application program relating to one or more search results. In an embodiment, computing apparatus 302 may execute one or more instructions to form one or more signals representing a training data set associated with one or more documents based at least in part on one or more portions of information derived from the user behavior log. For example, computing apparatus 302 may form a training set comprising one or more documents along with one or more portions of the user behavior log associated with those one or more documents. Computing apparatus 302 may further determine a correlation between the one or more documents and a prior response based at least in part on one or more aspects of the user behavior log. For example, computing apparatus 302 may employ one or more machine learning processes to determine a correlation between feature vectors associated with the one or more documents from the training set and one or more aspects of the user behavior log. For example, computing apparatus 302 may determine that one or more documents having a particular feature are likely to be displayed to a user, while one or more documents having a different particular feature are likely to be selected by a user. In an embodiment, computing apparatus 302 may further calculate a prediction score for one or more additional documents based, at least in part, on the determined correlation. For example, computing apparatus 302 may compare one or more feature vectors for one or more additional documents to one or more feature vectors associated with one or more documents from the training set. Based at least in part on such a comparison, computing apparatus 302 may calculate a prediction score for the one or more additional documents. In an embodiment, computing apparatus 302 may store one or more signals representative of an association of one or more additional documents with one or more categories of documents based at least in part on the prediction scores calculated for such one or more additional documents. For example, computing apparatus 302 may store one or more signals corresponding to additional documents having a prediction score above a threshold value with a first tier of documents, such as a first tier stored at computing apparatus 306. Likewise, computing apparatus 302 may store one or more signals corresponding to additional documents having a prediction score below such a threshold value with a second tier of documents, such as a second tier stored at computing apparatus 308, for example. In addition, computing apparatus 302 could store signals corresponding to additional documents having even lower prediction scores with a third tier of documents, such as a third tier of documents stored at computing apparatus 310, for example. It should be noted that these are merely illustrative examples relating to categorizing and/or storing documents and that claimed subject matter is not limited to the particular examples provided.

With regard to system 300, a user may generate a search query using an application program and a computing apparatus, such as computing apparatus 314 and transmit that query via network 316 to a computing apparatus executing one or more search engine application programs, such as computing apparatus 302, for example. At least in part in response to such a query, computing apparatus 302 may communicate such a query to one or more storage locations for search results, such as computing apparatuses 306, 308, and/or 310. In this example, computing apparatus 302 may first contact computing apparatus 306 at least in part to determine if any documents associated with a first category or tier of documents satisfy the user search query. If additional documents are desired, computing apparatus 302 may further contact computing apparatus 308 at least in part to determine if any documents associated with a second category or tier of documents satisfy the user query. Computing apparatus 302 may continue in this way moving from category to category until a desirable number a search results have been determined. In an embodiment, computing apparatus 302 may then return one or more search results to computing apparatus 314 via network 316. It should be noted that this is merely an illustrative example relating to search results and that claimed subject matter is not limited in this regard.

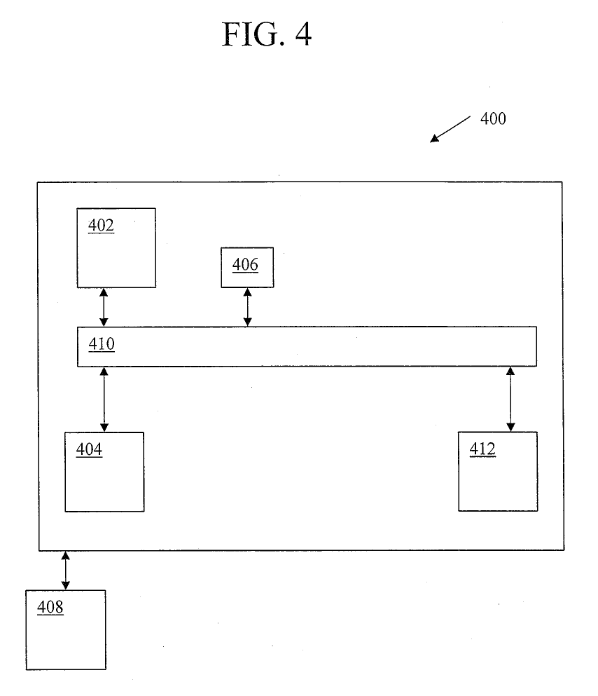

FIG. 4 is a schematic diagram or a special purpose computing apparatus in accordance with an embodiment 400. Embodiment 400 may comprise a computing apparatus or device, such as a special purpose computing apparatus having one or more processors programmed with one or more instructions to perform one or more particular functions and further adapted to receive one or more user behavior logs, for one or more training sets, determine a correlation between one or more documents associated with the training set and one or more aspects of the user behavior log, calculate one or more prediction scores for one or more additional documents based at least in part on the determined correlations and store the one or more additional documents in one or more categories of documents based at least in part on the calculated prediction scores. In addition, embodiment 400 may comprise one or more processors programmed with one or more instructions to perform one or more specific functions, such as processor 402. For example, processor 402 may be programmed with one or more instructions to perform one or more specific functions, such as one or more calculation functions, one or more machine learning functions, one or more assigning functions, and the like. Furthermore, embodiment 400 may comprise one or more memory devices, such as storage device 404 or computer readable medium 406. In addition, embodiment 400 may be operable to form one or more signals representing one or more calculated prediction scores, determined correlations, categorized documents, or the like. In addition, embodiment 400 may comprise one or more network communication adapters, such as network communication adaptor 408. In addition, embodiment 400 may be operable, at least in part in conjunction with network communication adaptor 408, to send or receive signals representing one or more actions such as one or more search queries, one or more user behavior logs, one or more categorizations of documents, one or more calculated prediction scores, or the like. Embodiment 400 may also comprise a communication bus, such as communication bus 410, operable to allow one or more connected components to communicate under appropriate circumstances. It should, however, be noted that these are merely illustrative examples relating to a computing apparatus and that claimed subject matter is not limited in this regard.

Some portions of the detailed description above are presented in terms of algorithms or symbolic representations of operations on binary digital signals stored within a memory of a specific apparatus or special purpose computing device or platform. In the context of this particular specification, the term specific apparatus, specific purpose computing device, special purpose computing apparatus, and/or the like may includes a general purpose computer or other computing device once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” and/or the like refer to actions or processes of a specific apparatus, such as a special purpose computer, special purpose computing apparatus, or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding description, various aspects of claimed subject matter have been described. For purposes of explanation, specific numbers, systems or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
receiving via a network communication adaptor of a special purpose computing apparatus one or more signals representing a user behavior log;
executing one or more instruction on said special purpose computing apparatus to form one or more signals representing a training data set associated with one or more documents based at least in part on one or more portions of information derived from said user behavior log;
determine a correlation between the one or more documents and a prior response;
calculate a prediction score for one or more additional documents based, at least in part, on said determined correlation; and
with said special purpose computing apparatus, store a signal representative of an association of one or more additional documents with one or more categories of documents in a memory device based at least in part on the prediction scores calculated for said one or more additional documents.

2. The method of claim 1, wherein said prior response comprises a likelihood that a particular document will be displayed to a user

3. The method of claim 1, wherein said prior response comprises a likelihood that a particular document will be selected by a user.

4. The method of claim 1, and further comprising executing one or more additional instructions on said special purpose computing apparatus to determine a correlation between said one or more documents and a prior response at least in part by analyzing one or more aspects of one or more feature vectors associated with said one or more documents along with said user behavior log.

5. The method of claim 1, and further comprising executing one or more additional instructions on said special purpose computing apparatus to calculate a prediction score for one or more additional documents at least in part by comparing one or more aspects of one or more feature vectors associated with said one or more documents to one or more aspects of one or more additional features vectors associated with said one or more additional documents along with said determined correlation.

6. The method of claim 1, wherein said one or more categories of documents comprise one or more tiers of documents.

7. The method of claim 6, wherein said one or more tiers of documents comprise one or more memory locations for storing information associated with documents.

8. The method of claim 7, wherein said assigning comprises assigning one of the one or more additional documents having a prediction score above a threshold value to a first tier of documents and assigning another one of the one or more additional documents having a prediction score below a threshold value to a second tier of documents.

9. An article comprising: a storage medium have instructions stored thereon, wherein said instructions, if executed by a special purpose computing apparatus, enable said special purpose computing apparatus to:
read one or more signals representative of a user behavior log from a memory device associated with said special purpose computing apparatus;
form one or more signals representing a training data set associated with one or more documents based at least in part on one or more portions of information derived from said user behavior log;
determine a correlation between the one or more documents and a prior response;
calculate a prediction score for one or more additional documents based at least in part on said determined correlation; and
store a signal representative of an association of one or more additional documents with one or more categories of documents based at least in part on the prediction scores calculated for said one or more additional documents.

10. The article of claim 9, wherein said prior response comprises a likelihood that a particular document will be displayed to a user.

11. The article of claim 9, wherein said prior response comprises a likelihood that a particular document will be selected by a user.

12. The article of claim 9, wherein said one or more categories of documents comprise one or more tiers of documents, wherein said one or more tiers of documents comprise one or more memory locations for storing information associated with documents.

13. The article of claim 12, wherein said instructions, if executed by said special purpose computing apparatus, further enable said special purpose computing apparatus to store one of the one or more additional documents having a prediction score above a threshold value to a first tier of documents and store another one of the one or more additional documents having a prediction score below a threshold value to a second tier of documents.

14. The article of claim 9, wherein said user behavior log comprises one or more signals representing one or more aspects of user behavior at least in part in response to one or more search results.

15. An apparatus comprising:
a special purpose computing apparatus;
said special purpose computing apparatus comprising a network communication adaptor to receive one or more signals representing a user behavior log;
said special purpose computing apparatus further comprising one or more processors programmed with one or more instructions to:
form one or more signals representing a training data set associated with one or more documents based at least in part on one or more portions of information derived from said user behavior log;
determine a correlation between the one or more documents and a prior response;
calculate a prediction score for one or more additional documents based at least in part on said determined correlation; and
store a signal representative of an association of one or more additional documents with one or more categories of documents based at least in part on the prediction scores calculated for said one or more additional documents.

16. The apparatus of claim 15, wherein said prior response comprises a likelihood that a particular document will be displayed to a user and/or selected by a user.

17. The apparatus of claim 15, wherein said user behavior log comprises one or more signals representing one or more aspects of user behavior at least in part in response to one or more search results.

18. The apparatus of claim 15, wherein said one or more aspects of user behavior comprises user selections of a link to a particular document, user interaction with a particular document, and/or an amount of time a user spends with a particular document.

19. The apparatus of claim 15, wherein said one or more categories of documents comprise one or more tiers of documents, wherein said one or more tiers of documents comprise one or more memory locations for storing information associated with documents.

20. The apparatus of claim 19, wherein said one or more processors are further programmed with one or more additional instructions to store signals representative of one of the one or more additional documents having a prediction score above a threshold value to a first tier of documents and store signals representative of another one of the one or more additional documents having a prediction score below a threshold value to a second tier of documents.
